(19) United States
(12) Patent Application Publication
(10) Pub. No.: US 2005/0096886 A1
(43) Pub. Date: May 5, 2005

(54) Method for generating and using a transformer model

(76) Inventors: Karen J. Smiley, Benson, NC (US); John C. Sutton, Cary, NC (US); Thomas E. Long, Wake Forest, NC (US); David N. Cox, Raleigh, NC (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/699,217

(22) Filed: Oct. 31, 2003

(51) Int. Cl. G06F 17/10

(52) U.S. Cl. 703/2

(57) ABSTRACT

A preferred method for generating a transformer model includes defining a data base by selecting a first and a second set of parameters for inclusion in the data base, the first set of parameters being representative of at least one of as-designed and as-built transformer data, the second set of parameters being representative of transformer performance data. The preferred method also includes storing data from a plurality of transformers in the data base, the data from a plurality of transformers corresponding to the first and second sets of parameters. The preferred method further includes determining interrelationships between the first and second sets of parameters by analyzing the data from a plurality of transformers using multivariate statistical analysis.

### CROSS REFERENCE TO RELATED APPLICATIONS

This application is related to copending patent application Ser. No. ______, filed on Oct. 31, 2003, entitled “Transformer Testing” (Attorney Docket: ABDT-0578/B030100), which is incorporated by reference herein in its entirety.

This application is also related to copending patent application Ser. No. ______, filed on Oct. 31, 2003, entitled “Transformer Performance Prediction” (Attorney Docket ABDT0583/B030070), which is incorporated by reference herein in its entirety.

This application is also related to copending patent application Ser. No. ______, filed on Oct. 31, 2003, entitled “Method for Evaluating a Transformer Design” (Attorney Docket ABDT0582/B030080), which is incorporated by reference herein in its entirety.

### FIELD OF THE INVENTION

The present invention relates to transformers for the transformation of electrical power. More particularly, the present invention relates to the generation and use of a mathematical representation, or model, of a transformer.

### BACKGROUND OF THE INVENTION

Electric power companies and utilities generate electrical power for consumers using power generation units. A power generation unit can be a coal-fired power plant, a hydroelectric power plant, a gas-turbine-driven generator, a diesel-engine-driven generator, a nuclear power plant, etc. The electrical power is transmitted to the consumer via transmission and distribution (T&D) systems. T&D systems can include power lines, protective switches, sectionalizing switches, breakers, reclosers, etc.

Electrical power is typically transmitted over a portion of the T&D system at relatively high voltages to minimize losses. T&D systems typically include transformers that step up the voltage to levels suitable for transmission with minimal losses. Transformers are also used to step down the relatively high transmission voltages to levels suitable for use by the consumer.

The malfunction or failure of a transformer can result in a power outage. The malfunction or failure of a relatively large transformer used, for example, in a substation can result in a power outage that affects a large numbers of consumers. Hence, purchasers of transformers (typically electric power companies and utilities) usually consider transformer reliability when making their buying decisions.

In addition, transformer purchasers usually consider the initial (purchase) cost and the operating costs when deciding whether to purchase a particular transformer. Operating costs are due in large measure to the internal losses within the transformer. These losses, in turn, are related to the efficiency of the transformer. Hence, purchasers of transformers usually demand that transformer manufacturers provide a product with a relatively high efficiency. Purchasers sometimes negotiate a contractual financial penalty from the manufacturer if a transformer does not meet a specified efficiency goal.

In view of the above demands, transformer manufacturers generally attempt to maximize the reliability and efficiency, and minimize the initial cost of their products. The design process for a transformer, however, can be a relatively complex process. Hundreds (or in some cases thousands) of design parameters can affect the cost and performance, e.g., the reliability and efficiency, of a transformer. Optimizing the design of a transformer depends, to a large extent, on a knowledge of the interrelationships between the design parameters and the performance of the transformer.

Conventional techniques for determining the interrelationships between design parameters and the performance of a transformer usually rely on theoretical relationships. For example, eddy current losses are believed to vary proportionately with the square of the product of frequency, flux density, and core-lamination thickness. In practice, however, many other design parameters are believed to affect eddy current losses. Moreover, some of the interrelationships that affect eddy current losses may yet be discovered. Conventional transformer design techniques, in general, do not address these factors.

Transformer designers, depending on experience and aptitude, may have empirical or anecdotal knowledge of how a relatively small amount of design parameters impact certain performance-related parameters. An empirical or anecdotal understanding of the hundred or thousands of interrelationships between the various design and performance-related parameters of a transformer, however, can be difficult or impossible for an individual designer to achieve.

Moreover, conventional transformer design techniques do not usually account for manufacturing or testing-related factors that can affect performance, e.g., problems with a particular manufacturing site, material supplier, or piece of production equipment, faulty calibration of test equipment, etc.

### SUMMARY OF THE INVENTION

A preferred method for generating a transformer model comprises defining a data base by selecting a first and a second set of parameters for inclusion in the data base, the first set of parameters being representative of at least one of as-designed and as-built transformer data, the second set of parameters being representative of transformer performance data. The preferred method also comprises storing data from a plurality of transformers in the data base, the data from a plurality of transformers corresponding to the first and second sets of parameters. The preferred method further comprises determining interrelationships between the first and second sets of parameters by analyzing the data from a plurality of transformers using multivariate statistical analysis.

Another preferred method for generating a transformer model comprises creating a data base for storing a first and a second set of data from a first previously-built transformer and a first and a second set of data from a second previously-built transformer. The preferred method also comprises inputting the first and second sets of data from the first and second transformers into the data base. The preferred method further comprises correlating variations between the first sets of data from the first and second previously-built transformers with variations between the second sets of data from the first and second previously-built transformers.

A preferred method for validating a design for a transformer comprises inputting data representing design specifications of the transformer into a transformer model, receiving data from the transformer model representing predicted performance characteristics of the transformer, and comparing the predicted performance characteristics to predetermined performance requirements for the transformer.

A preferred method for optimizing a first design parameter of a transformer comprises inputting a value for the first design parameter and values for a plurality of other design parameters of the transformer into a transformer model, and receiving data from the transformer model representing predicted performance characteristics of the transformer based on the first design parameter and the plurality of other design parameters for the transformer. The preferred method also comprises comparing the data representing the predicted performance characteristics of the transformer to predetermined performance requirements for the transformer. The preferred method further comprises varying the value of the first design parameter and repeating the previous steps until the predicted performance characteristics do not satisfy the predetermined performance requirements.

A preferred method for designing a transformer comprises inputting data representative of one or more performance-related requirements of the transformer into a transformer model, and receiving data from the transformer model representative of predicted design specifications for the transformer necessary to satisfy the one or more performance-related requirements.

A preferred embodiment of a computing system for generating a transformer model comprises a computer having an application processing and storage area. The application processing and storage area comprises a computing engine and a data base for storing data from a plurality of transformers. The data from a plurality of transformers corresponds to a first and a second set of parameters. The first set of parameters is representative of at least one of as-designed and as-built transformer data.

The second set of parameters is representative of transformer performance data. The computing engine is configured to determine interrelationships between the first and second sets of parameters by analyzing the data from a plurality of transformers using multivariate statistical analysis.

Another preferred embodiment of a computing system for generating a transformer model comprises a computer having an application processing and storage area. The application processing and storage area comprises a computing engine and a data base. The data base has stored therein a first and a second set of data from a first previously-built transformer and a first and a second set of data from a second previously built transformer. The computing engine is configured to correlate variations between the first sets of data from the first and second previously-built transformers with variations between the second sets of data from the first and second previously-built transformers.

A preferred method for generating a transformer model using a data base having a first and a second set of parameters included therein, the first set of parameters being representative of at least one of as-designed and as-built transformer data, the second set of parameters being representative of transformer performance data comprises storing data from a plurality of transformers in the data base, the data from a plurality of transformers corresponding to the first and second sets of parameters. The preferred method also comprises determining interrelationships between the first and second sets of parameters by analyzing the data from a plurality of transformers using multivariate statistical analysis.

A preferred method for generating a transformer model using a data base for storing a first and a second set of data from a first previously-built transformer and a first and a second set of data from a second previously-built transformer comprises inputting the first and second sets of data from the first and second transformers into the data base. The preferred method also comprises correlating variations between the first sets of data from the first and second previously-built transformers with variations between the second sets of data from the first and second previously-built transformers.

### BRIEF DESCRIPTION OF THE DRAWINGS

The foregoing summary, as well as the following detailed description of a preferred method, is better understood when read in conjunction with the appended diagrammatic drawings. For the purpose of illustrating the invention, the drawings show an embodiment that is presently preferred. The invention is not limited, however, to the specific instrumentalities disclosed in the drawings. In the drawings:

FIG. 1 is a diagrammatic illustration of a preferred embodiment of a computing system configured to perform a preferred method for generating and using a transformer model;

FIG. 2 is a diagrammatic illustration of a data package stored on the computing system shown in FIG. 1; and

FIG. 3 is a diagrammatic illustration of a preferred embodiment of a data network having a computing system configured for use with a transformer model in accordance with the preferred method.

### DETAILED DESCRIPTION OF PREFERRED EMBODIMENTS

A preferred method for generating and using a mathematical representation, or model, of a transformer is described herein. The model is generated using data mining techniques, and can be based on data representing test results, design specifications and as-built specifications of previously-built transformers. The model can be used, for example, to predict the performance of a particular transformer design before the design is built and tested.

The preferred method can be performed using the exemplary computing environment described in detail below. It should be noted that the preferred method is described in connection with this particular computing environment for exemplary purposes only. The preferred method can be used in connection with other types of computing environments.

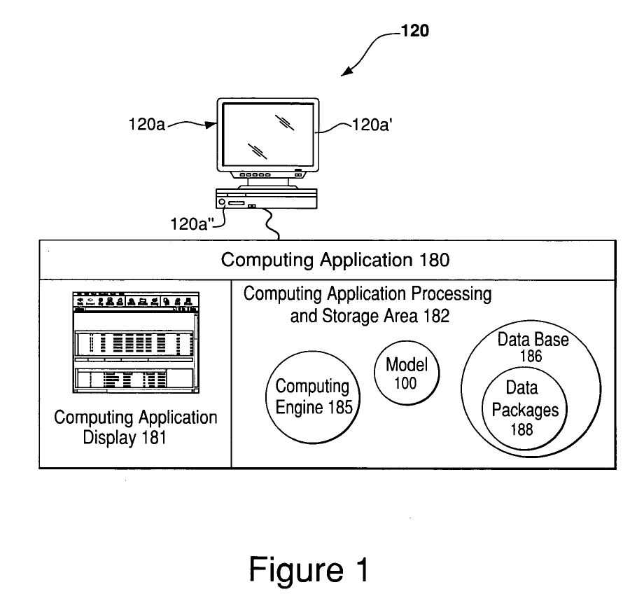

FIG. 1 depicts a computing system 120 capable of being configured to perform the preferred method. The computing system 120 comprises a computer 120a. The computer 120a includes a display device 120a′ and an interface and processing unit 120a″. The computer 120a executes a computing application 180. As shown, the computing application 180 includes a computing application processing and storage area 182, and a computing application display 181.

The computing application 180 can be configured to generate a model 100 of a transformer based on a predetermined set of inputs, as explained in detail below (the model 100 is depicted in diagrammatic form in FIG. 1). The model 100 can be used, for example, to predict the performance of a particular transformer design during the design process or the post-design validation process. For example, the model 100 can be used to generate predicated values for performance-related parameters such as load loss, no-load loss, impedance, operating temperature, short circuit strength, etc.

It should be noted that the computing system 120 can be used to generate the model 100 and, subsequently, to generate performance predictions and other information based on the model 100. Alternatively, the model 100 can be generated on a first computing system and transferred to a second computing system. The second computing system can then be used to generate the noted performance predictions and other information.

The computing application display 181 can include display content for use during the generation of the model 100, and during subsequent use of the model 100. A user (not shown) can interface with the computing application 180 through the computer 120a. The user can navigate through the computing application 180 to input, display, and generate data and information relating to the generation and use of the model 100. Information relating to the generation and use of the model 100 can be displayed to the user as display content via the computing application display 181.

The computing application processing and storage area 182 can include a computing engine 185. (Although the computing engine 185 is shown as being implemented as a single engine, it should be noted that the computing engine 185 can be implemented as more than one engine in alternative embodiments. Also, the various functions of the computing engine 185 can be distributed among multiple computing engines in any convenient fashion.)

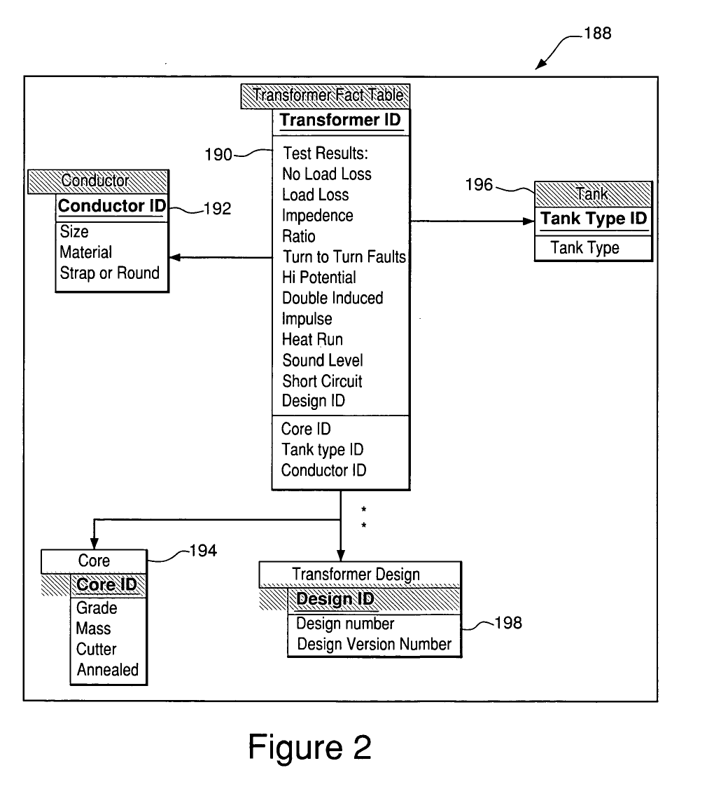

The preferred method comprises defining a data base 186. The data base 186 can be incorporated in to the application processing and storage area 182 (see FIG. 1). Data can be input to the data base 186 via the interface and processing unit 120a″ of the computer 120a. The data base 186 includes a plurality of data packages 188. Each data package 188 corresponds to a particular transformer that has previously been built and tested. Each data package 188 is preferably in the form of a multidimensional data structure commonly referred to as a “cube” among those skilled in statistical analysis. One of the data packages 188 is depicted in diagrammatic form in FIG. 2.

The data packages 188 each comprise a plurality of tables. For example, the data package 188 can comprise a first table 190. The first table 190 has data stored therein representing values of preselected parameters generated during testing of the corresponding transformer. These parameters can be selected so as to correspond to performance-erelated criteria specified by the customer or end user, e.g., load losses, no load losses, impedance, operating temperature, short circuit strength, etc. In other words, some or all of the parameters stored in the first table 190 can represent performance related parameters that should or must meet some type of specified requirement, goal, minimum etc.

(Other parameters that can be included in the table 190 include, for example, pressure rise; oil rise; top of unit oil temperature; top oil rise; top oil measured; average oil rise; maximum oil rise; gradient temperature at tested current; average duct temperature rise; winding temperature rise; resistance; polarity; instrumentation loss; shorting bar loss; eddies and strays, rms amps; rms watts; voltage. Moreover, it should be noted that multiple measurements of the same parameter are often acquired as a transformer operates under different conditions, e.g., different ambient temperature, different applied current, etc. The data table 190 can include data reflecting multiple measurements of the same parameter acquired under different conditions.)

The remaining tables in the data package 188 can hold as-designed (specification) or as-built data for the corresponding transformer. For example, the data package 188 can also include a second table 192 for storing data representing various characteristics of the conductor used in the transformer windings, e.g., dimensions, type and source of material, etc. It should be noted that values representing one or both of the as-designed and as-built values for each of the noted parameters can be stored in the second table 192 (and in all of the other tables in the data package 188 other than the first table 190).

The data package 188 can further include a third table 194 for storing data representing various characteristics of the transformer core, e.g., grade of material, overall mass, etc. In addition, the data package 188 can comprise a fourth table 196 for storing data representing the type of tank used in the corresponding transformer. The data package 188 can further comprise a fifth table 198 for storing data representing the design number or designation, and the design version of the corresponding transformer.

The above-noted arrangement of tables is commonly referred to as a “star schema” among those skilled in statistical analysis. Each table represents a “dimension” within the data package 188, with the centrally-located first table 190 representing a “measures table” within the star schema. The various parameters within a particular table represent “levels” of the table. This arrangement permits the data to be examined in various combinations of dimensions and levels. The data can also be examined as filtered subsets. (These respective techniques are commonly known among those skilled in statistical analysis as “slicing” and “dicing” the data.)

Any parameter that can potentially impact the performance or cost of the transformer can be included in the data base 186. (The “performance” of the transformer, as discussed above, can be defined in terms of various operating parameters specified by the manufacturer, customer, or end user as specifications, goals, minimums, etc.) More particularly, any parameter whose performance or cost-related impact a designer may wish to assess can be included in data packages 188 of the data base 186.

For example, data can be included to represent the particular plant at which the transformer was manufactured; the type and serial number of the winding machine used to form the windings; the type and serial number of the cutting machine used to cut the steel for in the transformer core; a data on which a particular piece of manufacturing equipment was retooled; the batch identifier, lot number, or supplier of a material used to fabricate a particular component; the calibration date of the test equipment used to test the transformer; the cost of materials; the results of quality-control tests performed on the materials (such as the specific gravity of the oil used in the transformer); the environmental conditions during manufacture of the transformer (such as barometric pressure, temperature, humidity); the number of layers of metal and insulating material in the transformer core; the type of insulating material; the total weight of the core; the type of oil used in the transformer; assembly instructions (such as bolt torque); dimension (lengths, widths, thicknesses) of components; any other parameters included on engineering drawings; etc.

The data package 188 for a particular application can include hundreds or thousands of different parameters. (A relatively small number of parameters are depicted in the exemplary data package 188, for clarity.) In practice, the benefits associated with assessing the performance-related effects of a relatively large number of parameters are counterbalanced factors such as the labor, cost, and practicality of collecting and compiling large amounts of data; the overall capacity of the data base and computing system used in a particular application; etc. Hence, the particular parameters selected for inclusion in each data package 188 are application dependent, and the particular configuration of the data package 188 depicted herein is presented for exemplary purposes only.

The preferred method also comprises inputting data from previously-built and tested transformers into the data base 186, in the form of the data packages 188, after the data base 186 has been defined in the above-described manner.

The preferred method further comprises generating the model 100 after the data base 186 has been defined and the above-noted data has been stored therein. The model 100 can be generated by analyzing the stored data using a multivariate statistical analysis technique such as cluster analysis.

The multivariate statistical analysis technique identifies trends in the data across the various data packages 188 stored in the data base 1.86. In particular, the multivariate statistical analysis correlates variations in the as-designed/as-built data from transformer to transformer with variations in the performance-related (as-tested) data from transformer to transformer. The multivariate statistical analysis thereby establishes interrelationships among the various data parameters included in the data base 186. (The term “data mining,” as used herein, refers to the use of multivariate statistical analysis techniques to perform the noted correlation of the data stored in the data base 186.)

Cluster analysis is a multivariate analysis technique that seeks to organize information about variables so that relatively homogenous groups, or “clusters,” can be formed. The preferred method can be performed using any of the various types of cluster analysis methods commonly known among those skilled in statistical analysis, such as joining (tree clustering), two-way joining, K-means clustering, expectation maximization clustering, etc. General background information regarding cluster analysis can be found, for example, in Multivariate Statistical Analysis, A Conceptual Introduction 2^{nd} Edition, S. K. Kachigan, Radius Press, 1991.

It should be noted that the use of cluster analysis is discussed for exemplary purposes only. Other types of multivariate statistical analysis techniques such as decision tree analysis, nearest neighbor, wavelets, and regression splines can be used in the alternative. General background information regarding these techniques can be found, for example, in Bayesian Methods for Nonlinear Classification and Regression, David G. T. Denison, Christopher C. Holmes, Bani K. Mall, John Wiley & Sons, Inc., 2002.

Software capable of performing the above-described data-mining process is available commercially. For example, the above-noted data mining process can be performed using the MICROSOFT® SQL Server 2000 Analysis Services data base management and analysis system, available from Microsoft Corporation.

The data mining process described above can produce a group of interrelationships between the various parameters stored in the base 186 based on the historical data stored therein (this group of interrelationships represents the model 100). The preferred method thus permits the cumulative experience gained from the building and testing of multiple transformers to be used to predict the performance of transformers that have not yet been built or tested.

The model 100 can be stored in the computing application processing and storage area 182 of the computing system 120 (see FIG. 1). A transformer designer can operate the model 100, i.e., the transformer designer can input data and commands, retrieve and review the output of the model 100, etc., using the display device 120a′ and the interface and processing unit 120a″ of the computer 120a. The model 100 can also be loaded onto another computing system or systems and operated thereon.

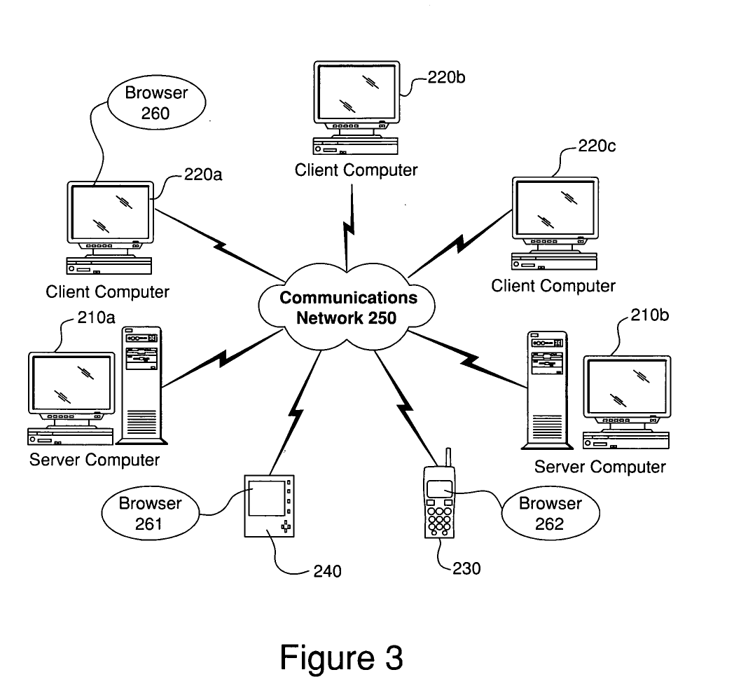

The model 100 can also be accessed via a data network 240 such as shown in FIG. 3. The data network 240 can include server computers 210a, 210b. The data network 240 can also include client computers 220a, 220b, 220c or other computing devices such as a mobile phone 230 or a personal digital assistant 240. The model 100 can be stored on any of the server computers 210a, 210b or client computers 220a, 220b, 220c.

The server computers 210a, 210b, client computers 220a, 220b, 220c, mobile phone 230, and personal digital assistant 240 can be communicatively coupled via, a communications network 250. The communications network 250 can be a wireless network, a, fixed-wire network, a local area network (LAN), a wide area network (WAN), an intranet, an extranet, the Internet, etc.

In a network environment in which the communications network 250 is the Internet, for example, the server computers 210a, 210b can be Web servers which communicate with the client computers 220a, 220b, 220c via any of a number of known communication protocols such as hypertext transfer protocol (HTTP), wireless application protocol (WAP), and the like. Each client computer 220a, 220b, 220c can be equipped with a browser 260 to communicate with the server computers 210a, 210b. Similarly, the personal digital assistant 240 can be equipped with a browser 261, and the mobile phone 230 can be equipped with a browser 262 to communicate with the server computers 210a, 210b.

The data network 240 can thus permit a transformer designer to input data to, and receive output from the model 100 at locations remote from the computing device on which the model 100 is stored and executed. (The model 100 can also be generated based on inputs from a remote location using a data network such as the data network 240.)

The preferred method can be implemented with a variety of network-based and standalone architectures, and therefore is not limited to the preceding example.

A transformer designer can access the model 100 via the interface and processing unit 120a″ of the computer 120a, or through a data network such as the data network 240. The input and output of the model 100 can be tailored to the particular type of analysis for which the model 100 is being used. For example, the computing system 120 can be configured to generate outputs, via the computing application display 181, in the form of tabular data, graphical representations of trends, formal reports, etc.

In one possible application of the model 100, a transformer designer can use the model 100 to assist in optimizing the design of a particular transformer. In particular, the designer can perform “what if” analyses by varying one or more of the design parameters, and evaluating the effect of such variation on the performance of the transformer being modeled.

The preceding technique can permit the designer to evaluate the effort of specific design parameters on the performance of the transformer. For example, the amount of steel in the core can be varied while the other design parameters are held constant, until a minimum value of steel content that meets a predetermined set of performance criteria is determined. (The inputs to the model 100 in this scenario are predetermined values for various design parameters of the transformer, and the outputs are values for various performance-related parameters.)

Thus, the production-related expenses (and the accompanying lost profits or decreased price-competitiveness) associated with over-designing a particular component can potentially be avoided by identifying such over-designs through the use of the preferred method. Conversely, the expenses associated with redesigning and replacing under-designed components can likewise be avoided through the use of the preferred method. Moreover, the identification of under-designed components during the design process can reduce the chances that such components will reach the field and adversely affect the reliability of the transformers in which they are used.

The model 100 can also be used to validate a particular design. In other words, values for various design parameters can be input to the model 100. The model 100 can predict and output values for various performance parameters, such as load and no-load loss, impedance, operating temperature, short circuit strength, etc. The predicted values can be compared to target or specification values to determine whether the predicted performance is satisfactory. The preferred method can thus be used to identify and correct potential design deficiencies in a transformer before the transformer is built, and can lead to greater confidence that a particular design will meet its performance criteria.

In another use of the model 100, one or more performance parameters can be input to the model 100 based on, for example, the requirements of a particular customer. The model 100 can output a series of predicted design parameters that satisfy the performance criteria. A transformer designer can thus obtain a set of design parameters needed to satisfy a particular set of customer requirements. Moreover, the transformer designer can likely generate a more accurate cost-estimate for the transformer using this technique than would otherwise be possible.

The use of a wide base of data that includes manufacturing-related data, e.g., the identification of production and test sites, material sources, test-instrumentation calibration dates, etc., can allow the performance-related effects of the manufacturing environment to be evaluated by the designer. The inclusion of data from transformers of different designs, different design versions, and different power ratings can likewise facilitate an evaluation of the effects of those particular factors on transformer performance.

Also, the inclusion of as-designed and as-built data in the data base 186 can facilitate the use of the model 100 to separate manufacturing-related deficiencies from design-related deficiencies. Moreover, the inclusion of data from transformers that have been operated in the field can permit the model 100 to be used to analyze how various performance parameters change over time.

The model 100 can also include data that identifies cost penalties associated with a shortfall in one or more performance parameters. The model 1100 can thus be configured to optimize transformer design from a cost standpoint.

The preferred method can thus permit the transformer designer to evaluate the effects of many factors that can potentially have an impact on transformer performance, and can thereby assist the designer in achieving an optimum design.

Program code (i.e., instructions) for performing the preferred method, including generating and using the model 100, can be stored on a computer-readable, medium, such as a magnetic, electrical, or optical storage medium, including without limitation a floppy diskette, CD-ROM, CD-RW, DVD-ROM, DVD-RAM, magnetic tape, flash memory, hard disk drive, or any other machine-readable storage medium, wherein, when the program code is loaded into and executed by a data-processing machine, such as a computer, the data-processing machine becomes an apparatus for practicing the invention.

The program code can also be transmitted over a transmission medium; such as over electrical wiring or cabling or fiber optic cabling, over a network, including the Internet or an intranet, or via any other form of transmission wherein, when the program code is received and loaded into and executed by a data-processing machine, such as a computer, the data-processing machine becomes an apparatus for practicing the preferred method. When implemented on a general-purpose processor, the program code combines with the processor to provide an apparatus that operates analogously to specific logic circuits.

The foregoing description is provided for the purpose of explanation and is not to be construed as limiting the invention. While the invention has been described with reference to preferred embodiments or preferred methods, it is understood that the words which have been used herein are words of description and illustration, rather than words of limitation. Furthermore, although the invention has been described herein with reference to particular structure, methods, and embodiments, the invention is not intended to be limited to the particulars disclosed herein, as the invention extends to all structures, methods and uses that are within the scope of the appended claims. Those skilled in the relevant art, having the benefit of the teachings of this specification, may effect numerous modifications to the invention as described herein, and changes may be made without departing from the scope and spirit of the invention as defined by the appended claims.

1. A method for generating a transformer model, comprising:
defining a data base by selecting a first and a second set of parameters for inclusion in the data base, the first set of parameters being representative of at least one of as-designed and as-built transformer data, the second set of parameters being representative of transformer performance data;
storing data from a plurality of transformers in the data base, the data from a plurality of transformers corresponding to the first and second sets of parameters; and
determining interrelationships between the first and second sets of parameters by analyzing the data from a plurality of transformers using multivariate statistical analysis.

2. The method of claim 1, wherein determining interrelationships between the first and second sets of parameters by analyzing the data from a plurality of transformers using multivariate statistical analysis comprises:
identifying a first set of variations between the data from a plurality of transformers corresponding to the first set of parameters;
identifying a second set of variations between the data from a plurality of transformers corresponding to the second set of parameters; and
correlating the first and second set of variations.

3. The method of claim 1, wherein determining interrelationships between the first and second sets of parameters analyzing the data from a plurality of transformers using multivariate statistical analysis comprises determining interrelationships between the first and second sets of parameters by analyzing the data from a plurality of transformers using cluster analysis.

4. The method of claim 1, wherein determining interrelationships between the first and second sets of parameters by analyzing the data from a plurality of transformers using multivariate statistical analysis comprises determining interrelationships between the first and second sets of parameters by analyzing the data from a plurality of transformers using decision-tree analysis.

5. The method of claim 1, wherein the transformer performance data comprises test results.

6. The method of claim 5, wherein the test results comprise measurements relating to at least one of load loss, impedance, transformation ratio, turn-to-turn faults, high-potential test results, double induced test results, impulse test results, heat run test results, sound level, and short circuit test results.

7. The method of claim 1, wherein the data base comprises a first table for storing the data corresponding to the first set of data parameters, and a second table for storing the data representative of the second set of data parameters.

8. The method of claim 7, wherein the data base comprises a plurality of data packages each corresponding to a different one of the plurality of transformers and each comprising one of the first tables and one of the second tables.

9. The method of claim 7, wherein the data base further comprises a third table for storing the data representative of the first set of data parameters, and the first, second, and third tables are arranged in a star schema.

10. The method of claim 1, wherein the as-designed transformer data comprises design specifications and the as-built transformer data comprises as-built specifications.

11. The method of claim 1, wherein the first set of parameters includes data relating to a transformer manufacturing environment.

12. The method of claim 11, wherein the first set of parameters includes identifying information relating to at least one of a manufacturing location, a winding machine used to wind a transformer core, a cutting machine used to cut material used in a transformer core, a retooling date for transformer manufacturing equipment, and a material batch used to manufacture a transformer component.

13. The method of claim 1, wherein the first set of parameters includes data relating to a transformer testing environment.

14. The method of claim 13, wherein the first set of parameters includes data relating to a calibration data of test equipment.

15. The method of claim 1, wherein the first set of parameters includes data relating cost penalties associated with transformer performance shortfalls.

16. The method of claim 1 wherein the as-designed and as-built transformer data comprise information relating to at least one of design number; design version; grade of core material; core mass; core annealing; tank type; conductor size; conductor material; and type of conductor.

17. The method of claim 16, wherein the data base comprises:
a first table having the transformer performance data stored therein;
a second table having the information relating to the design number and design version stored therein;
a third table having the information relating to the grade of core material, core mass, and core annealing stored therein;
a fourth table having the information relating to the tank type stored therein; and a fifth table having the information relating to the conductor size, conductor material, and type of conductor stored therein.

18. The method of claim 1, wherein the data base is structured as a cube.

19. A method for generating a transformer model, comprising:
creating a data base for storing a first and a second set of data from a first previously-built transformer and a first and a second set of data from a second previously-built transformer;
inputting the first and second sets of data from the first and second transformers into the data base; and
correlating variations between the first sets of data from the first and second previously-built transformers with variations between the second sets of data from the first and second previously-built transformers.

20. The method of claim 19, wherein correlating variations between the first sets of data from the first and second previously-built transformers with variations between the second sets of data from the first and second previously-built transformer comprises correlating the variations between the first sets of data from the first and second previously-built transformers with the variations between the second sets of data from the first and second previously-built transformer using multivariate statistical analysis.

21. The method of claim 20, wherein correlating the variations between the first sets of data from the first and second previously-built transformers with the variations between the second sets of data from the first and second previously-built transformer using cluster analysis.

22. The method of claim 20, wherein correlating the variations between the first sets of data from the first and second previously-built transformers with the variations between the second sets of data from the first and second previously-built transformer using decision-tree analysis.

23. The method of claim 19, wherein the first sets of data for the first and second transformers comprise transformer performance data.

24. The method of claim 23, wherein the transformer performance data comprises test results.

25. The method of claim 19, wherein the second sets of data comprise at least one of as-designed and as-built transformer data.

26. The method of claim 25, wherein the as-designed transformer data comprises design specifications and the as-built transformer data comprises as-built specifications.

27. The method of claim 25, wherein the second sets of data include data relating to a transformer manufacturing environment.

28. The method of claim 27, wherein the second sets of data include identifying information relating to at least one of a manufacturing location, a winding machine used to wind a transformer core, a cutting machine used to cut material used in a transformer core, a retooling date for transformer manufacturing equipment, and a material batch used to manufacture a transformer component.

29. The method of claim 19, wherein the second sets of data include data relating to a transformer testing environment.

30. The method of claim 29, wherein the second sets of data include data relating to a calibration data of test equipment.

31. The method of claim 19, wherein the second sets of data include data relating cost penalties associated with transformer performance shortfalls.

32. A method for validating a design for a transformer, comprising:
inputting data representing design specifications of the transformer into a transformer model generated according to the method of claim 1;
receiving data from the transformer model representing predicted performance characteristics of the transformer; and
comparing the predicted performance characteristics to predetermined performance requirements for the transformer.

33. A method for optimizing a first design parameter of a transformer, comprising:
(a) inputting a value for the first design parameter and values for a plurality of other design parameters of the transformer into a transformer model generated in accordance with the method of claim 1;
(b) receiving data from the transformer model representing predicted performance characteristics of the transformer based on the first design parameter and the plurality of other design parameters for the transformer;
(c) comparing the data representing the predicted performance characteristics of the transformer to predetermined performance requirements for the transformer; and
(d) varying the value of the first design parameter and repeating steps (a)-(c) until the predicted performance characteristics do not satisfy the predetermined performance requirements.

34. A method for designing a transformer, comprising:
inputting data representative of one or more performance-related requirements of the transformer into a transformer model created in accordance with claim 1; and
receiving data from the transformer model representative of predicted design specifications for the transformer necessary to satisfy the one or more performance-related requirements.

35. A computing system for generating a transformer model, comprising a computer having an application processing and storage area, the application processing and storage area comprising a computing engine and a data base for storing data from a plurality of transformers, the data from a plurality of transformers corresponding to a first and a second set of parameters, the first set of parameters being representative of at least one of as-designed and as-built transformer data, the second set of parameters being representative of transformer performance data, wherein the computing engine is configured to determine interrelationships between the first and second sets of parameters by analyzing the data from a plurality of transformers using multivariate statistical analysis.

36. The system of claim 35, wherein the computing engine is configured to determine interrelationships between the first and second sets of parameters by analyzing the data from a plurality of transformers using cluster analysis.

37. The system of claim 35, wherein the computing engine is configured to determine interrelationships between the first and second sets of parameters by analyzing the data from a plurality of transformers using decision-tree analysis.

38. The system of claim 35, wherein the computing engine is configured to determine interrelationships between the first and second sets of parameters by:
identifying a first set of variations between the data from a plurality of transformers corresponding to the first set of parameters;
identifying a second set of variations between the data from a plurality of transformers corresponding to the second set of parameters; and
correlating the first and second set of variations.

39. The system of claim 35, wherein the data base comprises a first table for storing the data corresponding to the first set of data parameters, and a second table for storing the data representative of the second set of data parameters.

40. The method of claim 39, wherein the data base comprises a plurality of data packages each corresponding to a different one of the plurality of transformers and each comprising one of the first tables and one of the second tables.

41. A computing system for generating a transformer model, comprising a computer having an application processing and storage area, the application processing and storage area comprising a computing engine and a data base, the data base having stored therein a first and a second set of data from a first previously-built transformer and a first and a second set of data from a second previously-built transformer, the computing engine being configured to correlate variations between the first sets of data from the first and second previously-built transformers with variations between the second sets of data from the first and second previously-built transformers.

42. A method for generating a transformer model using a data base having a first and a second set of parameters included therein, the first set of parameters being representative of at least one of as-designed and as-built transformer data, the second set of parameters being representative of transformer performance data, the method comprising:
storing data from a plurality of transformers in the data base, the data from a plurality of transformers corresponding to the first and second sets of parameters; and
determining interrelationships between the first and second sets of parameters by analyzing the data from a plurality of transformers using multivariate statistical analysis.

43. A method for generating a transformer model using a data base for storing a first and a second set of data from a first previously-built transformer and a first and a second set of data from a second previously-built transformer, the method comprising:
inputting the first and second sets of data from the first and second transformers into the database; and
correlating variations between the first sets of data from the first and second previously-built transformers with variations between the second sets of data from the first and second previously-built transformers.
